(19) United States
(12) Patent Application Publication
(10) Pub. No.: US 2006/0231647 A1
(43) Pub. Date: Oct. 19, 2006

(54) Fuel injection valve

(76) Inventors: Guenther Hohl, Stuttgart (DE); Marco Vorbach, Remseck (DE)

Correspondence Address: KENYON & KENYON LLP, ONE BROADWAY, NEW YORK, NY, 10004, US

(21) Appl. No.: 10/563,667

(22) PCT Filed: May 2, 2005
(86) PCT No.: PCT/EP05/51997

§ 371 Date: May 18, 2006

(30) Foreign Application Priority Data
Jul. 13, 2004 (DE) 10 2004 033 842.6

(51) Int. Cl. F02M 51/00

(52) U.S. Cl. 239/585.1

(57) ABSTRACT

A fuel injector for the direct injection of fuel into the combustion chamber of an internal combustion engine includes a valve needle, which is arranged in a nozzle body, is actuable by an actuator and acted upon by a restoring spring such that a valve closure member, which is in operative connection to the valve needle and faces the combustion chamber, is kept in sealing contact on a valve seat surface in the non-actuated state of the actuator. A surface of the fuel injector has a concave design in a transition region between the nozzle body and the valve-closure member.

### FIELD OF THE INVENTION

The present invention relates to a fuel injector.

### BACKGROUND INFORMATION

Described in German Published Patent Application No. 101 52 415, for example, is an outwardly opening fuel injector having a conical sealing seat. The fuel injector includes a valve needle, which is guided in a nozzle body, is actuable by an actuator and acted upon by a restoring spring such that a valve-closure member, which is in operative connection with the valve needle, is retained in sealing contact on a valve-seat surface. Formed on a downstream end of the fuel injector is a projection, which juts out beyond the valve-closure body of the fuel injector.

A particular disadvantage of the fuel injector described in German Published Patent Application No. 101 52 415 is that the manufacture of the raised area of the nozzle body compared to the valve-closure body, while protecting the conical sealing seat from damage, is labor-intensive in the production and itself is susceptible to damage because of its exposed position, such damage having an adverse effect on the jet pattern of the fuel injector and also on the desired protective function of the raised region.

### SUMMARY

In contrast, a fuel injector according to an example embodiment of the present invention may provide that simple measures with respect to the contour of the nozzle body and the valve-closure body may provide reliable protection of the sealing seat against mechanical damage during transportation and installation of the fuel injector in that a transition region between the nozzle body and the valve-closure body has a concave design.

An angle between the mutually abutting surfaces of the nozzle body and the valve-closure body may amount to less than 180°, so that the sum of the two edge angles of the edges on the nozzle body and the valve-closure body is greater than 180°, i.e., the two edges are obtuse-angled.

Moreover, it may be provided that the transition region with the edges is positioned in a recessed manner compared to a surface plane of the fuel injector.

Example embodiments of the present invention are described below in greater detail in the following description with reference to the appended Figures.

### BRIEF DESCRIPTION OF THE DRAWINGS

FIG. 1 is a schematic cross-sectional view through a fuel injector according to an exemplary embodiment of the present invention.

FIG. 2 is a schematic comparative cross-sectional view of the fuel injector illustrated in FIG. 1, in region II in FIG. 1, and a conventional fuel injector.

FIG. 3 is a schematic comparative illustration of a sealing seat of a conventional fuel injector and a fuel injector according to an example embodiment of the present invention in an open state of the fuel injector.

### DETAILED DESCRIPTION

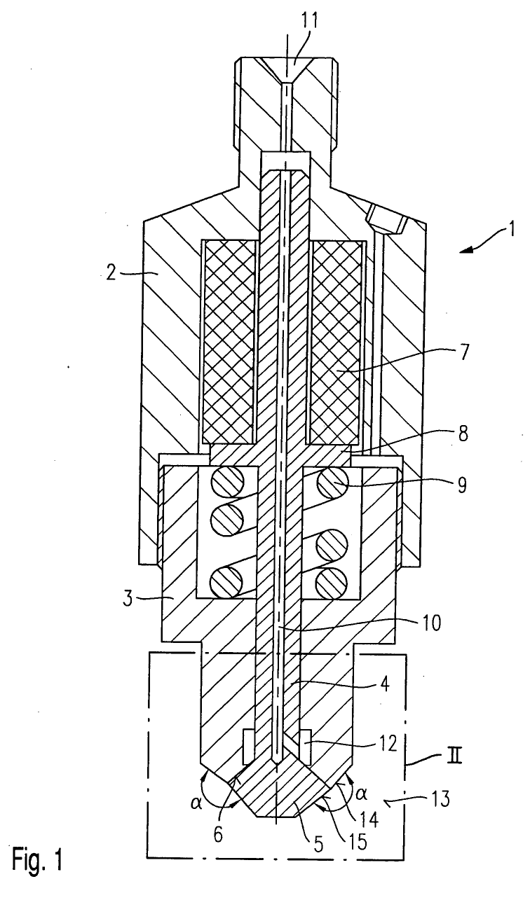

An exemplary embodiment of a fuel injector 1, illustrated in FIG. 1, is arranged in the form of a fuel injector 1 for fuel-injection systems of mixture-compressing internal combustion engines having externally supplied ignition. Fuel injector 1 may be particularly suited for the direct injection of fuel into a combustion chamber of an internal combustion engine.

Fuel injector 1 includes a housing body 2 and a nozzle body 3, in which a valve needle 4 is positioned. Valve needle 4 is in operative connection to a valve closure member 5, which cooperates with a valve seat surface 6 to form a sealing seat. The fuel injector is an outwardly opening fuel injector 1. It includes an actuator 7, which is arranged as a piezoelectric actuator 7. On one side, the actuator is braced on housing body 2, and on the other side it is braced on a shoulder 8, which is in operative connection to valve needle 4. Downstream from shoulder 8 is a restoring spring 9, which in turn is braced on nozzle body 3.

Valve needle 4 has a fuel channel 10 through which the fuel, conveyed through an inflow-side central fuel feed 11, is guided to the sealing seat. On the inflow side of the sealing seat, a swirl chamber 12 is formed into which fuel channel 10 discharges.

In the neutral state of fuel injector 1, the force of restoring spring 9 acts upon shoulder 8 counter to the lift direction, such that valve closure member 5 is held in sealing contact on valve seat surface 6. When piezoelectric actuator 7 is energized, it expands in the axial direction, counter to the spring force of restoring spring 9, so that shoulder 8 with valve needle 4, which is joined to shoulder 8 by force-locking, is moved in the lift direction. Valve-closure member 5 lifts off from valve-seat surface 6, and the fuel supplied via fuel channel 10 is spray-discharged. When the energizing current is switched off, the axial expansion of piezoelectric actuator 7 is reduced, so that the pressure of restoring spring 9 moves valve needle 4 counter to the lift direction. Valve closure member 5 sets down on valve seat surface 6, and fuel injector 1 is closed.

Conventional fuel injectors may have a convex transition region 13 in the area of the sealing seat, as schematically illustrated on the right side in FIG. 1. This surface shape, which is made up of a surface 14 of nozzle body 3 and a surface 15, abutting thereon on the downstream side, of valve-closure member 5, in most cases is chosen to ensure easy manufacturability and a smooth surface. However, it may be disadvantageous that edges 16, 17 of nozzle body 3 and valve closure body 5, respectively, are exposed due to the convex shape of transition region 13, and may be damaged as a result, for example, during transportation or installation of fuel injector 1. Since the shape of edges 16, 17 is responsible for the form of the mixture cloud and the jet pattern, damage in this region may have an adverse effect on the cylinder charge, on the combustion and on the emission values of the internal combustion engine.

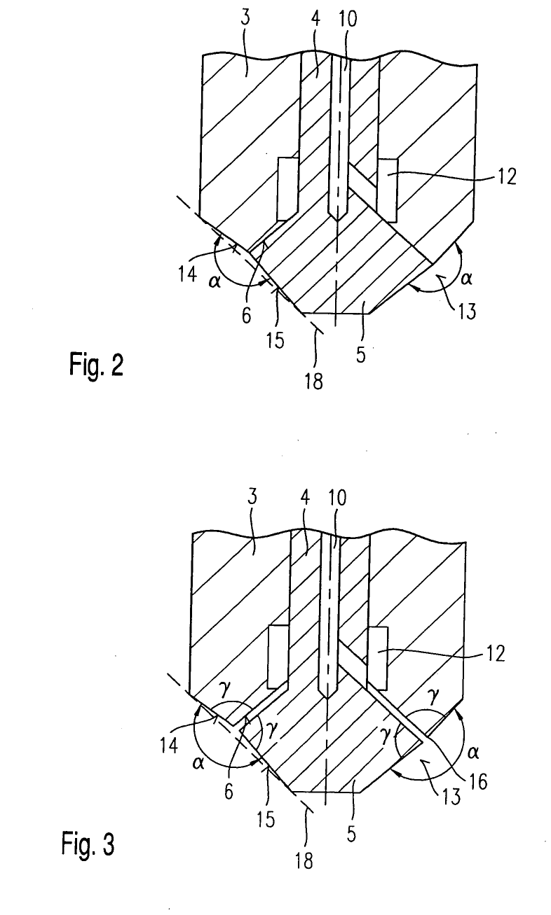

In contrast thereto, according to an example embodiment of the present invention, transition region 13 in the area of the region of the sealing seat does not have a convex, but a concave shape, as illustrated in FIG. 1 on the left. The measures hereof are illustrated in FIGS. 2 and 3 in enlarged form and explained in greater detail in the following description.

FIGS. 2 and 3 illustrate, in partial cross-sectional views, the cut-away portion—denoted by II in FIG. 1—from fuel injector 1 configured according to an example embodiment of the present invention as illustrated in FIG. 1 in the open and closed state of fuel injector 1. The same or similar components have been provided with matching reference signs.

As already mentioned earlier, conventional fuel injectors have a convex transition region 13 in the area of the sealing seat, where an angle a enclosed by surfaces 14 and 15 is greater than, or at most precisely 180°. This causes a raised or at best smooth transition region 13 where—as can be gathered clearly from FIG. 3 on the right—edges 16 and 17 jut out since the sum of two edge angles γ are significantly smaller than 90° due to large angle α. However, sharp edges 16 and 17 are susceptible to damage such as notches, which may occur when fuel injector 1 is transported or installed.

Therefore, as illustrated in FIGS. 2 and 3 on the left, a concave arrangement is provided for transition region 13 of fuel injector 1 in the area of the sealing seat, so that angle α between surfaces 14 and 15 is smaller than 180°. As a result, the sum of both edge angles γ of edges 16, 17 on nozzle body 3 and valve-closure body 5 is greater than 180°, i.e., individual edge angles γ are greater than 90°, and the two edges 16, 17 are obtuse-angled. As a result, edges 16 and 17 may be more robust with respect to damage. In addition, edges 16 and 17 are also protected by the concave form of transition region 13, since they are recessed relative to a surface plane 18, indicated by dashed lines, of fuel injector 1.

It should be understood that example embodiments of the present invention may also able to be utilized for electromagnetically actuable fuel injectors 1.

1 to 7. (canceled)

8. A fuel injector, comprising:
a nozzle body; and
a valve needle positioned in the nozzle body, actuable by an actuator and acted upon by a restoring spring to keep a valve-closure member, which is operatively connected to the valve needle and faces a combustion chamber of an internal combustion engine, in sealing contact with a valve-seat surface in a non-actuated state of the actuator;
wherein a surface of the fuel injector includes a concave shape in a transition region between the nozzle body and the valve-closure member.

9. The fuel injector according to claim 8, wherein the fuel injector is adapted for direct injection of fuel into the combustion chamber.

10. The fuel injector according to claim 8, wherein the transition region is formed by two mutually abutting surfaces of the nozzle body and the valve-closure member.

11. The fuel injector according to claim 10, wherein an angle between the surfaces is smaller than 180°.

12. The fuel injector according to claim 8, wherein one edge is formed on each of the nozzle body and the valve-closure member.

13. The fuel injector according to claim 12, wherein the edges include edge angles that each amount to at least 90°.

14. The fuel injector according to claim 13, wherein a sum of the edge angles amounts to at least 180°.

15. The fuel injector according to claim 8, wherein the transition region is recessed relative to a surface plane.
